(19) United States
(12) Patent Application Publication
(10) Pub. No.: US 2015/0101036 A1
(43) Pub. Date: Apr. 9, 2015

(54) NETWORK FILTERING DEVICE, NETWORK FILTERING METHOD AND COMPUTER-READABLE RECORDING MEDIUM HAVING STORED THEREIN A PROGRAM

(71) Applicant: FUJITSU LIMITED, Kawasaki-shi (JP)

(72) Inventors: Hisashi Kojima, Yokosuka (JP); Masahiro Nakada, Ota (JP)

(21) Appl. No.: 14/498,150

(22) Filed: Sep. 26, 2014

(30) Foreign Application Priority Data
Oct. 7, 2013 (JP) 2013-209909

(51) Int. Cl. H04L 29/06; H04L 12/26

(52) U.S. Cl. CPC H04L 63/0245; H04L 43/10
USPC 726/13

(57) ABSTRACT

Provided is effective protection of a machine which is connected to a network by including a monitoring unit configured to monitor an apparatus which receives a data packet through a network, a storage unit configured, when abnormality of the apparatus is detected, to store a first data packet which causes the abnormality, a comparison unit configured to compare a second data packet received by the apparatus and the first data packet, a specification unit configured to specify a portion in the first data packet which is changed by a threshold or more from the second data packet, and a registration unit configured to register data of the specified portion.

### CROSS-REFERENCE TO RELATED APPLICATION

This application is based upon and claims the benefit of priority of the prior Japanese Patent application No. 2013-209909, filed on Oct. 7, 2013, the entire contents of which are incorporated herein by reference.

### FIELD

The embodiments discussed herein are related to a network filtering device, a network filtering method and a computer-readable recording medium having stored therein a program.

### BACKGROUND

In recent years, a method of black-box security testing called fuzzing is widely used. A fuzzing tool applies a large amount of test data considered to be effective for detecting vulnerability to a test target product regardless of its type so as to detect the vulnerability. For example, unknown vulnerability such as buffer overflow and integer overflow is found out through the fuzzing. In addition, since recently the fuzzing tool has been available to anyone, there is a concern about that an ill-intended person easily finds out unknown vulnerability of a product.

It is ideal that strong security measures are considered at the point of sale for the product connected to a network against attacks from the network.

Patent Document 1: Japanese Laid-open Patent Publication No. 2004-334607

However, after the above-mentioned product is sold and transferred to a customer, the vulnerability of the product is newly found out in many cases.

Further, since a fuzzing method has a lot of flexibility, a fuzzing tool may fail to detect the vulnerability while another fuzzing tool detects the vulnerability. Thus, there is a possibility that an attacker attacks products or systems using a method or a tool which is different from a fuzzing technique/fuzzing tool used in development. Therefore, there is a concern that an unknown vulnerability may be found out, and misused.

### SUMMARY

The network filtering device includes a monitoring unit configured to monitor an apparatus which receives a data packet through a network, a storage unit configured, when abnormality of the apparatus is detected, to store a first data packet which causes the abnormality, a comparison unit configured to compare a second data packet received by the apparatus and the first data packet, a specification unit configured to specify a portion in the first data packet which is changed by a threshold or more from the second data packet, and a registration unit configured to register data of the specified portion.

Further, the network filtering method includes monitoring an apparatus which receives a data packet through a network, storing, when abnormality of the apparatus is detected, a first data packet which causes the abnormality, comparing a second data packet received by the apparatus and the first data packet, specifying a portion in the first data packet which is changed by a threshold or more from the second data packet, and registering data of the specified portion.

Further, computer-readable recording medium having stored therein a program for causing a computer to execute a network filtering process includes monitoring an apparatus which receives a data packet through a network, storing, when abnormality of the apparatus is detected, a first data packet which causes the abnormality, comparing a second data packet received by the apparatus and the first data packet, specifying a portion in the first data packet which is changed by a threshold or more from the second data packet, and registering data of the specified portion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a functional configuration of a network filtering device as an example of a first embodiment;

FIG. 2 is a diagram illustrating a hardware configuration of the network filtering device as an example of the first embodiment;

FIG. 3 is a diagram illustrating a reception packet which is stored in a packet storage unit of the network filtering device as an example of the first embodiment;

FIG. 4 is a diagram for describing a creation method of criterion information in the network filtering device as an example of the first embodiment;

FIG. 5 is a diagram illustrating a prevention target list in the network filtering device as an example of the first embodiment;

FIG. 6 is a diagram illustrating an updated prevention target list in the network filtering device as an example of the first embodiment;

FIG. 7 is a flowchart for describing a process in the network filtering device as an example of the first embodiment; and

FIG. 8 is a diagram for describing a creation method of criterion information in a network filtering device as a second embodiment of the invention.

### DESCRIPTION OF EMBODIMENT(S)

Hereinafter, embodiments of the network filtering device and the network filtering method will be described with reference to the drawings. However, the following embodiments are given as merely exemplary, and it is not intended to exclude various modifications and technical applications which are not specified in the embodiments. In other words, the embodiments can be implemented in various forms (such as combinations of the respective embodiments) within a scope not departing from the spirit thereof. Further, there is no purpose of exclusively including only the components in the drawings, but other functions can be included.

### (A) Description of First Embodiment

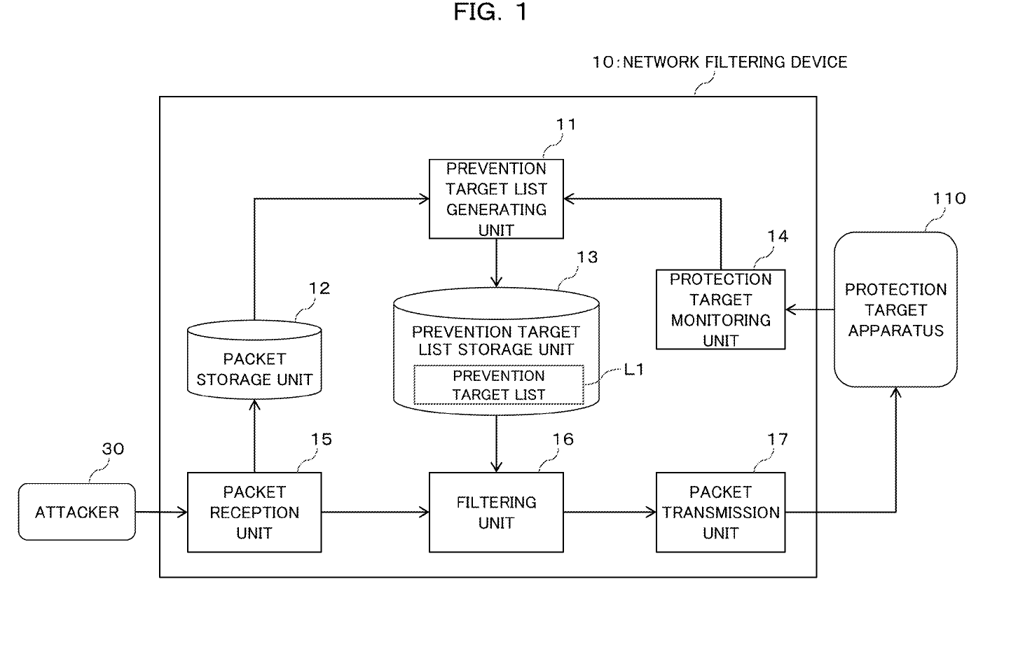

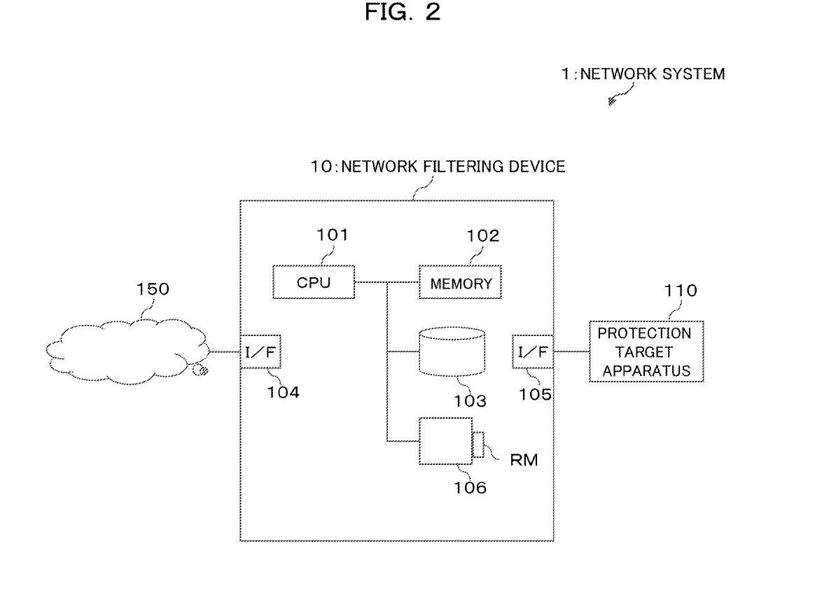

FIG. 1 is a diagram illustrating a functional configuration of a network filtering device 10 as an example of a first embodiment, and FIG. 2 is a diagram illustrating a hardware configuration thereof.

As illustrated in FIG. 2, the network filtering device 10 is disposed between a network 150 and a protection target apparatus 110, and filters data transferred from the network 150 to the protection target apparatus (apparatus) 110. The filtering interrupts data which threatens the vulnerability of the protection target apparatus 110.

The protection target apparatus 110 may be any apparatus which can be connected to the network 150. As a specific example of the protection target apparatus 110, a server, a personal computer, a hand-held computer, a game machine, a television, a home appliance, a navigation system, a mobile phone, and the like are exemplified.

As illustrated in FIG. 1, the network filtering device 10 includes a prevention target list generating unit 11, a packet storage unit 12, a prevention target list storage unit 13, a protection target monitoring unit 14, a packet reception unit 15, a filtering unit 16, and a packet transmission unit 17.

The packet reception unit 15 receives a packet which is transmitted from the network 150 to the protection target apparatus 110. The packet reception unit 15 sequentially sends the received packet to the filtering unit 16 which will be described. Further, the packet reception unit 15 causes the packet storage unit (a storage unit) 12 to sequentially store a copy of the received packet.

The packet storage unit (the storage unit) 12 stores the packet (reception packet) received by the packet reception unit 15. In the packet storage unit 12, as described below, a packet (a cause packet; a first data packet) which causes the failure in the protection target apparatus 110 and a packet (a second data packet) which is received by the protection target apparatus 110 before the cause packet are stored.

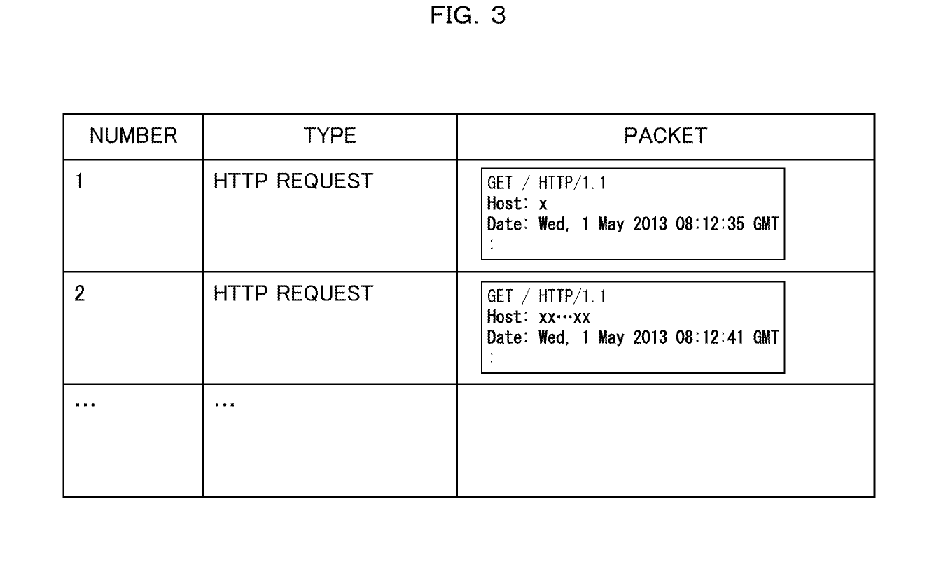

FIG. 3 is a diagram illustrating the reception packet which is stored in the packet storage unit 12 of the network filtering device 10 as an example of the first embodiment. In the example illustrated in FIG. 3, the reception packet is stored in association with information indicating the type (a packet type) thereof. Further, in the packet storage unit 12, the reception order (number) is also managed for a plurality of packets. The example illustrated in FIG. 3 illustrates a case where two packets of which the packet type is a hypertext transfer protocol (HTTP) request are stored.

In addition, in the example illustrated in FIG. 3, the reception packet is illustrated in a table format for convenience's sake, but the storage format of data is not limited thereto while various modifications can be made.

The packet transmission unit 17 transmits, to the protection target apparatus 110, a packet which is transmitted from the network 150 to the protection target apparatus 110 and received by the network filtering device 10 before arriving at the protection target apparatus 110. The packet transmission unit 17 transmits, to the protection target apparatus 110, data which is filtered by the filtering unit 16 to be described below among the packets transmitted from the network 150 to the protection target apparatus 110.

The protection target monitoring unit (the monitoring unit) 14 is a unit which monitors the protection target apparatus 110, so that the unit monitors a behavior of the protection target apparatus 110 and detects the occurrence of a failure (abnormality) in the protection target apparatus 110. Specifically, the protection target monitoring unit 14 detects the occurrence of a predetermined failure (abnormality) which is considered as a failure caused by a fuzzing attack in the protection target apparatus 110.

As a failure caused by the fuzzing attack, for example, rebooting, transition to a no-response state (freeze, hang-up, stall, and system down), transition to a power shutdown state, and the like of the protection target apparatus 110 are included. In addition, the protection target monitoring unit 14 is not limited to the above configuration, and other behaviors may be detected as a failure of the protection target apparatus 110.

Further, in a case where the protection target apparatus 110 is a computer such as a server, the protection target monitoring unit 14 may investigate whether the abnormality of the protection target apparatus 110 occurs by analyzing the output of a console port (not illustrated). The reason for the analysis on the output of the console port is that the output of the console port such as the server generally includes various types of information notifying the abnormality of the server. Further, the protection target monitoring unit 14 may transmit an activation confirming signal such as “ping” to the protection target apparatus 110 so as to confirm whether there is a response after a predetermined period of time. In a case where there is no response, it can be seen that there is a possibility for the protection target apparatus 110 to be down or be hanged up. Therefore, it is possible to confirm whether the abnormality of the protection target apparatus 110 occurs by transmitting a packet for confirming the activation. Alternatively, the abnormality can be detected in various manners such that a command for confirming a status is transmitted from the protection target monitoring unit 14 to the protection target apparatus 110 to confirm various statuses of the protection target apparatus 110.

When detecting the occurrence of a failure in the protection target apparatus 110, the protection target monitoring unit 14 informs the prevention target list generating unit 11.

The prevention target list generating unit 11 creates criterion information which is used as a determination reference for detecting a packet having possibility of causing the failure when the packet is received in the protection target apparatus 110, and registers the criterion information in a prevention target list L1.

When receiving a notification of the fact that the occurrence of the failure in the protection target apparatus 110 is detected from the protection target monitoring unit 14, the prevention target list generating unit 11 creates the criterion information and registers it in the prevention target list L1.

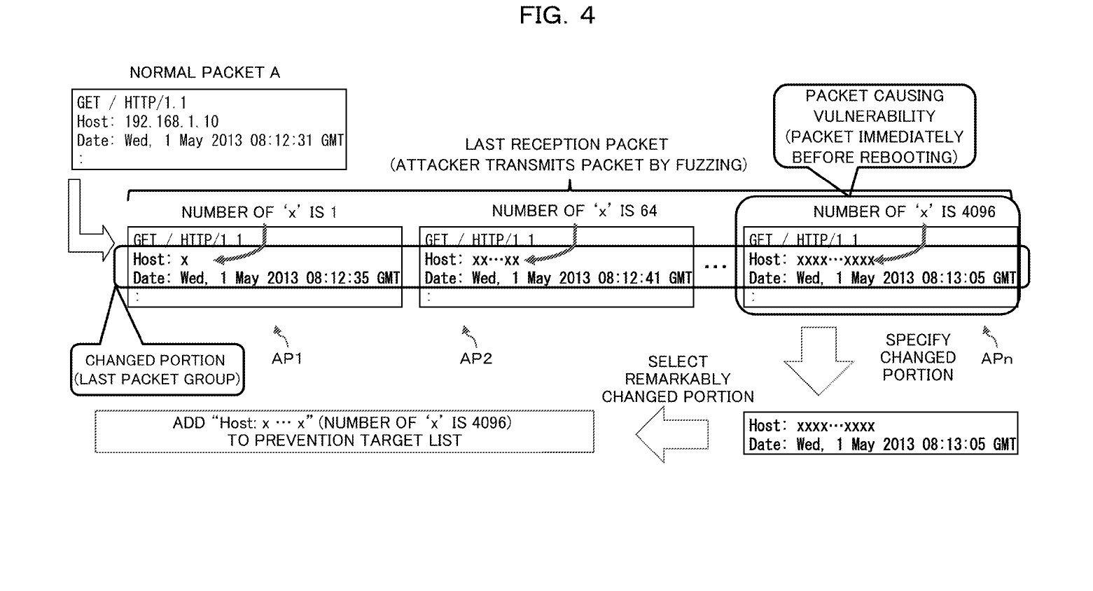

FIG. 4 is a diagram for describing a creation method of criterion information in the network filtering device 10 as an example of the first embodiment.

Generally, in the fuzzing attack, a plurality of attacking packets are created by being continuously changed according to a certain rule such as changing in data length of a part (a changed packet item) of a packet (a normal packet) for transmission. In other words, among the plurality of attacking packets thus continuously transmitted, the attacking packets adjacently transmitted are different in the value of the changed packet item.

FIG. 4 illustrates an example in which the plurality of attacking packets are created based on a normal packet A. In the example illustrated in FIG. 4, a plurality of attacking packets AP1 to APn (n is a natural number) are illustrated while the Internet protocol (IP) address “192.168.1.10” registered in the data item “Host” for the header of the normal packet A is changed in various types.

In addition, FIG. 4 illustrates an example in which the protection target apparatus 110 is assumed as a Web server and receives a packet as a hypertext transfer protocol (HTTP) request.

Since only a text is included in the HTTP request, a typical text comparison method can be used to specify a changed portion.

Herein, the normal packet A shows a portion of various headers of a HTTP protocol, and is a packet of a GET method. Such information shown in the normal packet A is included in one packet. The attacking packets AP1 to APn show exemplary patterns which are created by an attacker 30 using a known fuzzing technique. These attacking packets AP1 to APn are patterns which are mainly used for checking buffer overflow.

In the first embodiment, by the fuzzing attack, character ‘x’ included in the data item “Host” is changed in number to create the plurality of attacking packets, each of which is changed in number of the character string included in the data item “Host”.

Specifically, in the attacking packet AP1, one ‘x’ is set as the data item “Host”, and in the attacking packet AP2, 64 ‘x’s are set as the data item “Host” in a continuous data format. Further, in the attacking packet APn, 4096 ‘x’s are set as the data item “Host” in a continuous data format.

For example, it is assumed that a failure is not detected in the protection target apparatus 110 when the attacking packets AP1 and AP2 are received, and then when the attacking packet APn is received, the failure is detected.

In such a case, the attacking packet APn which is received immediately before the failure is detected in the protection target apparatus 110 is estimated as a cause packet (the first data packet) which causes the failure in the protection target apparatus 110.

Then, in the cause packet, a portion (a changed portion) which is changed with respect to the last received other packets (the attacking packets) AP1 and AP2 is estimated as a factor (an abnormality cause) which causes the failure in the protection target apparatus 110.

Herein, the prevention target list generating unit 11 specifies a portion in the cause packet which is changed with respect to the last received other attacking packets AP1 and AP2.

Herein, as an example, using the fact that a packet is the HTTP request, the changed portion is separated from each header and further separated into a data item and a value (separation using “:”) of the header, and values of the same data items are compared to each other. Herein, the character strings are not simply compared, but some criteria are assumed to be used as a comparison method. For example, lengths of the character strings are used as a criterion herein.

In the example illustrated in FIG. 4, the value of the data item “Host” and the value of the data item “Date” are different from each other in the attacking packets AP1 to APn.

Therefore, the prevention target list generating unit 11 specifies the value of the data item “Host” and the value of the data item “Date” in the cause packet as portions which are changed with respect to the last received other attacking packets AP1 and AP2.

In this way, the data item “Date” and the data item “Host” are included in the changed portion. However, since the data item “Date” is information indicating a reception time of the packet, it is a matter of course that the numerical values thereof are different between the attacking packets AP1 to APn.

Herein, the respective packets are different in the value of the data item “Date”, but all packets have the same data length.

On the other hand, as described above, the number of ‘x’s in the value of the data item “Host” is made different among the attacking packets AP1 to APn by the fuzzing. In other words, the value of the data item “Host” in each packet is made remarkably different in the length of the character string (the number of characters, the data length).

In the first embodiment, the prevention target list generating unit 11 specifies an abnormality causing packet item among the plurality of packets based on the number of characters of the value of the data item. Specifically, in a case where the length (the number of characters) of the character string of the value of the data item is different, for example, by 256 or more in the plurality of packets, it is considered as “remarkably different”.

The lengths of the respective data items “Host” in the reception packets are “1”, “64”, . . . , and “4096”. The maximum value of the number of character ‘x’s set in the data item “Host” is “4096” of the attacking packet APn, and the minimum value is “1” of the attacking packet AP1.

A difference (a difference value) between the maximum value and the minimum value is calculated as 4096−1=4095. The prevention target list generating unit 11 compares the calculated difference value “4095” and a predetermined threshold (for example, “256”). In a case where the calculated difference value is larger than the threshold, the prevention target list generating unit 11 determines that a remarkably-changed portion is the length of the value of the data item “Host”, and the data item “Host” is the abnormality causing packet item.

In this case, since the number of characters of the value of the data item “Host” has the minimum value “1” and the maximum value “4096” having a difference therebetween by 256 or more, it can be considered that the number of characters of the value of the data item “Host” is remarkably changed.

In other words, the prevention target list generating unit (a specification unit) 11 specifies a portion (the abnormality causing packet item) in the cause packet which is changed by the threshold or more from the other reception packets.

On the other hand, the number of characters set in the data item “Date” is the same in the respective attacking packets AP1 to APn. Therefore, the differences (the difference values) between the maximum values and the minimum values are calculated as “0”.

The prevention target list generating unit 11 compares the calculated difference value “0” and a predetermined threshold (for example, “30”). Since the calculated difference value “0” is smaller than the threshold, the data item “Date” is excluded from the abnormality causing packet item.

In other words, in the first embodiment, an item of which the number of characters is changed by the threshold or more from another packet having no detected failure is specified as the abnormality causing packet item in the cause packet. Therefore, the data item, such as the reception time and date and the transmission time and date of the packet, which is naturally considered to have a different numerical value in the plurality of packets can be excluded from the abnormality causing packet item, so that the process can be performed with efficiency.

As described above, actually there is a strong possibility that the failure occurs due to the vulnerability in the protection target apparatus 110, and the abnormality causing packet item is specified by using the last received packet and the packet received before that last packet. Then, it can be analyzed “in a case where the length of the data item “Host” is 4096 or more, the vulnerability occurs” with reference to the data (abnormality causing data; xx . . . xx (the number of ‘x’s is 4096) in the example) of the abnormality causing packet item (the data item “Host” in the example) in the attacking packet APn which is the cause packet. Therefore, the result is added to the prevention target list L1, so that it is possible to block a future attacking packet in which the length of the data item “Host” is “4096” or more from arrival at the protection target apparatus 110.

The prevention target list generating unit 11 determines the abnormality causing packet item, which is specified as above in the attacking packet APn, as the criterion information, and registers the abnormality causing data specified as the criterion information in the prevention target list L1. In other words, the prevention target list generating unit 11 extracts the value of the abnormality causing packet item from the attacking packet APn which causes the failure in the protection target apparatus 110, and registers the extracted value as the item “threshold” of the prevention target list L1.

In other words, the prevention target list generating unit (a registration unit) 11 specifies a portion (the abnormality causing packet item) in the cause packet which is changed by the threshold or more from the other reception packets, and registers the data of the abnormality causing packet item of the cause packet in the prevention target list L1.

The prevention target list L1 stores the criterion information used as a criterion for specifying a packet (a risk packet) which may cause the failure in the protection target apparatus 110 when the packet is received by the protection target apparatus 110. The filtering unit 16 to be described below performs a filtering on data transmitted from the network 150 using the prevention target list L1.

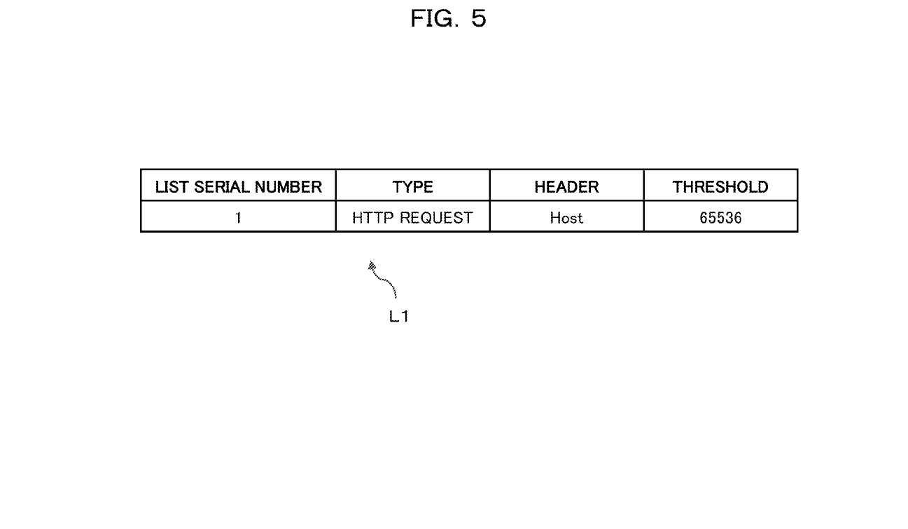

FIG. 5 is a diagram illustrating a prevention target list L1 in the network filtering device 10 as an example of the first embodiment.

The prevention target list L1 illustrated in FIG. 5 includes a list serial number, a type, a header, and a size threshold as items.

The list serial number is a number which is uniquely set to an entry to be registered in the prevention target list L1, and serves as an identifier of the entry. The type represents a packet type.

The header represents the abnormality causing packet item in the header of the packet. The threshold is a threshold used when the filtering unit 16 to be described below filters the data transmitted from the network 150, and the value of the abnormality causing packet item extracted from the attacking packet APn by the prevention target list generating unit 11 is stored.

In the filtering unit 16 to be described below, in a case where the value of the abnormality causing packet item in the header of the received packet is larger than the threshold of the prevention target list L1, it is determined that the received packet is a risk packet.

Further, when the prevention target list generating unit 11 extracts the value of the abnormality causing packet item from the attacking packet APn to register the extracted value as the item “threshold” of the prevention target list L1, it is considered a case where the same abnormality causing packet item is already registered in the prevention target list L1.

In such a case, the prevention target list generating unit 11 first compares the value of the threshold previously stored in the prevention target list L1 and the value of the abnormality causing packet item newly extracted from the attacking packet APn. Then, in a case where the value of the abnormality causing packet item newly extracted from the attacking packet APn is smaller than the value of the threshold previously stored in the prevention target list L1, the prevention target list generating unit 11 replaces (updates) the value of the threshold of the prevention target list L1 with the value of the abnormality causing packet item newly extracted from the attacking packet APn.

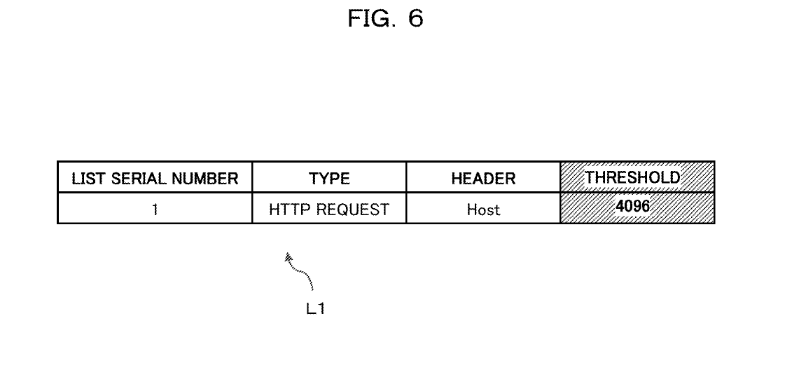

FIG. 6 is a diagram illustrating an updated prevention target list L1 in the network filtering device 10 as an example of the first embodiment. In the prevention target list L1 illustrated in FIG. 6, the threshold “65536” of the prevention target list L1 illustrated in FIG. 5 is updated with the value “4096” of the abnormality causing packet item newly extracted from the attacking packet APn.

The prevention target list storage unit 13 stores the prevention target list L1 which is created by the prevention target list generating unit 11. The filtering unit 16 to be described below reads the prevention target list L1 from the prevention target list storage unit 13, and uses the list for filtering the data transmitted from the network 150.

The filtering unit 16 filters the data transmitted from the network 150 to the protection target apparatus 110. Through the filtering, it is possible to interrupt data (the risk packet) which threatens the vulnerability of the protection target apparatus 110.

In the filtering unit 16, each packet received by the packet reception unit 15 from the network 150 and the prevention target list L1 stored in the prevention target list storage unit 13 are compared. Specifically, the filtering unit 16 compares the threshold of the changed packet item registered in the prevention target list L1 and the value of the corresponding data item in the header of the received packet.

Further, in a case where a plurality of thresholds are registered in the prevention target list L1, the filtering unit 16 compares the plurality of thresholds and the value of the corresponding data item in the header of the received packet.

In a case where the value of the data item in the received packet is equal to or larger than the threshold registered in the prevention target list L1, the received packet is determined as a risk packet which may cause the failure in the protection target apparatus 110.

The filtering unit 16 interrupts the transmission of the risk packet, and blocks the packet not to arrive at the protection target apparatus 110. In other words, the filtering unit 16 serves as an interrupt unit which interrupts the transmission of the risk packet to the protection target apparatus 110.

The risk packet which is blocked in the filtering unit 16 may be discarded, or may be stored (separated) in a memory 102, a storage device 103, and the like to be described below such that a manager performs analysis of the risk packet later.

On the other hand, in a case where the value of the data item in the received packet is smaller than the threshold registered in the prevention target list L1, the filtering unit 16 determines that the received packet is a stable packet which may not cause the failure in the protection target apparatus 110, and transmits the packet to the packet transmission unit 17.

In addition, in a case where the data received from the network 150 is converted by compression or the like, the filtering unit 16 may perform the filtering on an inversely-converted data.

Further, the filtering unit 16 may output a positive or negative result of the comparison between the value of the data item in the received packet and the threshold registered in the prevention target list L1 to the packet transmission unit 17.

In addition, in the specification, the positive result of the filtering unit 16 means that the value of the data item in the received packet is equal to or larger than the threshold registered in the prevention target list L1, and the data should be interrupted not to arrive at the protection target apparatus 110. The negative result of the filtering unit 16 means the opposite situation, and the data should arrive at the protection target apparatus 110.

In addition, in the network filtering device 10, the data output from the protection target apparatus 110 to the network 150 may pass through without any change.

Further, the filtering unit 16 may compare each packet received by the packet reception unit 15 and a pattern which is stored in a pattern storage unit (not illustrated) in advance. As a result of the comparison, in a case where at least a part of the received packet is matched or substantially matched with the pattern, the filtering unit 16 determines the packet as a risk packet, interrupts the transmission of the risk packet, and blocks the packet not to arrive at the protection target apparatus 110.

As illustrated in FIG. 2, the network filtering device 10 includes a central processing unit (CPU) 101, the memory 102, the storage device 103, a medium reading device 106, and network interfaces (I/F) 104 and 105.

The network interface 104 is an interface device which communicably connect the network filtering device 10 and the network 150 (for example, a local area network (LAN) adaptor). Then, the network interface 104 serves as the packet reception unit 15 described above.

The network interface 105 is an interface device which communicably connects the network filtering device 10 and the protection target apparatus 110 (for example, the LAN adaptor). Then, the network interface 105 serves as the packet transmission unit 17 described above.

In addition, the network interfaces 104 and 105 are not limited to the LAN adaptor, and may be implemented in various forms such as an adaptor for optical communication.

The memory 102 is a storage device which includes a read only memory (ROM) and a random access memory (RAM). In the ROM of the memory 102, a software program relating to network filtering control or data for the program is written. The software program on the memory 102 is read by the CPU 101 for execution. Further, the RAM of the memory 102 is used as a primary memory or a working memory.

The storage device 103, for example, is a storage device which can store data such as a hard disk drive (HDD) and a nonvolatile memory, and stores an operating system (OS), various types of programs, and data for the programs.

Further, in the memory 102 and the storage device 103, the packet received by the packet reception unit 15 and the prevention target list L1 are stored. In other words, the memory 102 and the storage device 103 serve as the packet storage unit 12 and the prevention target list storage unit 13 described above.

The CPU 101 is a processing device which performs various controls and calculations, and realizes various functions by executing the OS or the program stored in the memory 102 or the storage device 103. In other words, the CPU 101 serves as the prevention target list generating unit 11, the protection target monitoring unit 14, and the filtering unit 16 described above.

The medium reading device 106 is configured to allow a recording medium RM to be mounted thereon. In a state where the recording medium RM is mounted, the medium reading device 106 is configured to read information stored in the recording medium RM. In the example, the recording medium RM is a portable type. The recording medium RM is a computer-readable recording medium, and includes a flexible disk, a CD (such as a CD-ROM, a CD-R, and a CD-RW), a DVD (such as a DVD-ROM, a DVD-RAM, a DVD-R, a DVD+R, a DVD-RW, a DVD+RW, a HD DVD), a Blu-ray disk, a magnetic disk, an optical disk, a magneto-optical disk, or a semiconductor memory for example.

In addition, the program (the network filtering program) for realizing the functions as the prevention target list generating unit 11, the protection target monitoring unit 14, and the filtering unit 16 described above, for example, is provided in a form of the above-mentioned recording medium RM written thereon. Then, the computer reads the program from the recording medium RM, and transmits and stores the program in an internal storage device or an external storage device for use. Further, the program, for example, may be stored in the storage device (the recording medium) such as the magnetic disk, the optical disk, and the magneto-optical disk, and provided to the computer from the storage device through a communication path.

When the functions as the prevention target list generating unit 11, the protection target monitoring unit 14, and the filtering unit 16 are realized, the program stored in the internal storage device (the memory 102 in the embodiment) is executed by a microprocessor (the CPU 101 in the embodiment) of the computer. At this time, the program stored in the recording medium may be read by the computer for execution.

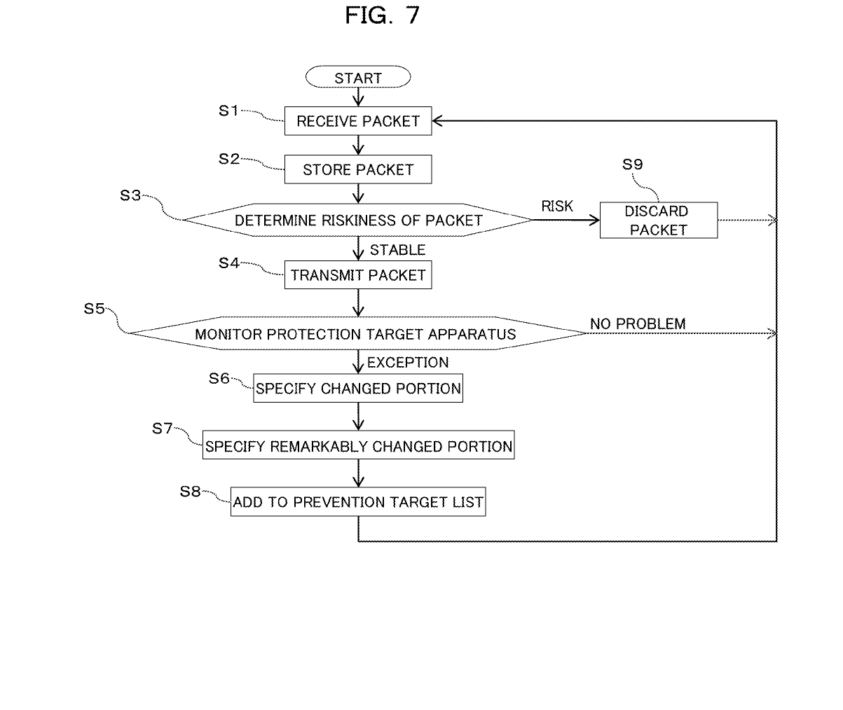

The process of the network filtering device 10 as an example of the first embodiment having the configurations as described above will be described according to a flowchart illustrated in FIG. 7 (Steps S1 to S9).

When the attacker 30 transmits the attacking packet by the fuzzing to the protection target apparatus 110, the packet reception unit 15 receives the packet in Step S1.

In Step S2, the packet reception unit 15 stores a copy of the received packet (the reception packet) in the packet storage unit 12. Herein, an upper limit (for example, 10 packets) of the number of reception packets to be stored is previously set in the packet storage unit 12. In a case where the number exceeds the upper limit, the earliest reception packet stored in the packet storage unit 12 is eliminated, and a new reception packet is added. Further, the packet reception unit 15 transmits the reception packet to the filtering unit 16.

In Step S3, the filtering unit 16 makes a determination on the riskiness of the packet. The determination is performed based on the prevention target list L1. For example, in a case where the reception packet is an HTTP request, and a data length (the number of characters) of a specific value of the header becomes equal to or larger than the length set as a threshold of the prevention target list L1, the reception packet is determined as a risk packet. For example, in the example illustrated in FIG. 5, in a case where the value of the Host header of the reception packet becomes equal to or larger than 65536, the reception packet is considered as the risk packet.

In a case where the reception packet is determined as the risk packet (see “risk” route of Step S3), the filtering unit 16 discards the reception packet, and blocks the packet not to arrive at the protection target apparatus 110 in Step S9. Therefore, it is possible to block that the protection target apparatus 110 receives the risk packet, and to protect the protection target apparatus 110. Then, the procedure returns to Step S1 to prepare for the next reception packet.

On the other hand, in a case where the reception packet is a stable packet (see “stable” route in Step S3), the packet transmission unit 17 transmits the packet to the protection target apparatus 110 in Step S4.

Then, in Step S5, the protection target monitoring unit 14 monitors the behavior of the protection target apparatus 110. In a case where a failure is not detected in the behavior of the protection target apparatus 110 (see “no problem” route of Step S5), the procedure returns to Step S1.

On the other hand, in a case where a failure is detected in the protection target apparatus 110 (see “exception” route of Step S5), in Step S6, the prevention target list generating unit 11 determines that the packet transmitted from the packet transmission unit 17 immediately before the failure occurs is a cause packet which brings abnormality to the protection target apparatus 110. The prevention target list generating unit 11 starts an addition operation to the prevention target list L1 based on the cause packet.

First, the prevention target list generating unit 11 specifies a portion which is changed in each packet compared to another packet while referring to all packets stored in the packet storage unit 12. In the example illustrated in FIG. 4, the value of the data item “Host” and the value of the data item “Date” are changed respectively among the attacking packets AP1 to APn.

Next, in Step S7, the prevention target list generating unit 11 specifies an abnormality causing packet item which is a remarkably changed portion among the changed portions specified in Step S6. In the example illustrated in FIG. 4, the prevention target list generating unit 11 compares the attacking packet APn and the attacking packets AP1 and AP2 which do not cause the failure so as to specify a portion (the abnormality causing packet item) which is remarkably changed in the attacking packet APn with respect to the attacking packets AP1 and AP2. In detail, the prevention target list generating unit 11 specifies a portion which is changed in the attacking packet APn by the threshold or more with respect to the attacking packets AP1 and AP2, and thus specifies the abnormality causing packet item in the attacking packet APn.

The prevention target list generating unit 11 extracts a maximum value and a minimum value of the number of characters which are set in each data item of the plurality of attacking packets AP1 to APn, and calculates a difference (a difference value) between the maximum value and the minimum value.

Then, the prevention target list generating unit 11 compares the calculated difference value and the predetermined threshold. In a case where the calculated difference value is larger than the threshold, the data item is determined as an abnormality causing packet item.

In other words, in the first embodiment, an item of which the number of characters is changed by the threshold or more from another packet having no detected failure is specified as the abnormality causing packet item in the cause packet.

In Step S8, the prevention target list generating unit 11 extracts data (abnormality causing data) of the abnormality causing packet item which is specified as described above from the attacking packet APn, and registers the extracted data as the item “threshold” of the prevention target list L1. Therefore, the abnormality causing data which causes a failure in the protection target apparatus 110 is registered in the prevention target list L1, and hereafter it becomes possible to protect the protection target apparatus 110 against the similar risk packet. Then, the procedure returns to Step S1.

Further, at this time, in a case where the same abnormality causing packet item is already registered in the prevention target list L1, the prevention target list generating unit 11 compares the value of the threshold previously stored in the prevention target list L1 and the value of the abnormality causing packet item newly extracted from the cause packet. Then, in a case where the value of the abnormality causing packet item extracted from the cause packet is smaller than the value of the threshold previously stored in the prevention target list L1, the value of the threshold of the prevention target list L1 is replaced (updated) with the value of the abnormality causing packet item extracted from the cause packet.

Therefore, the prevention target list L1 can be updated with the abnormality causing data which causes the failure based on the failure detected by the protection target apparatus 110, and hereafter it becomes possible to protect the protection target apparatus 110 against the similar risk packet.

In this way, according to the network filtering device 10 as an example of the first embodiment, in a case where the failure occurs in the protection target apparatus 110 by the fuzzing attack, the cause packet is specified. Then, the changed portions which are changed among the plurality of packets are specified by comparing these packets stored in the packet storage unit 12. Then, a portion which is changed by the threshold or more is specified among the changed portions to specify the abnormality causing packet item, and data of the abnormality causing packet item is extracted from the cause packet and registered in the prevention target list L1 as the threshold.

Therefore, the prevention target list L1 can be automatically created and updated based on the attacking packet which generates the failure in the protection target apparatus 110. In other words, even after the protection target apparatus 110 is shipped, the prevention target list L1 can be updated and the reliability can be improved. In other words, it is possible to effectively protect the protection target apparatus 110 against its vulnerability.

Further, since the filtering unit 16 filters the packet received by the packet reception unit 15 using the created and updated prevention target list L1, the protection target apparatus 110 can be protected against the similar attacking packet, thereby realizing a strong security.

### (B) Description of Second Embodiment

The invention is not limited to the above-mentioned embodiment, and various modifications can be made in a scope not departing from the spirit of the invention.

For example, in the network filtering device 10 as an example of the above-mentioned first embodiment, the prevention target list generating unit 11 specifies the abnormality causing packet item among the plurality of packets based on the number of characters of the value of the data item, but the embodiment is not limited thereto. In the second embodiment, the prevention target list generating unit 11 specifies the abnormality causing packet item among the plurality of packets based on the size of the value of the data item, and the other portions are configured similarly to the network filtering device 10 of the first embodiment.

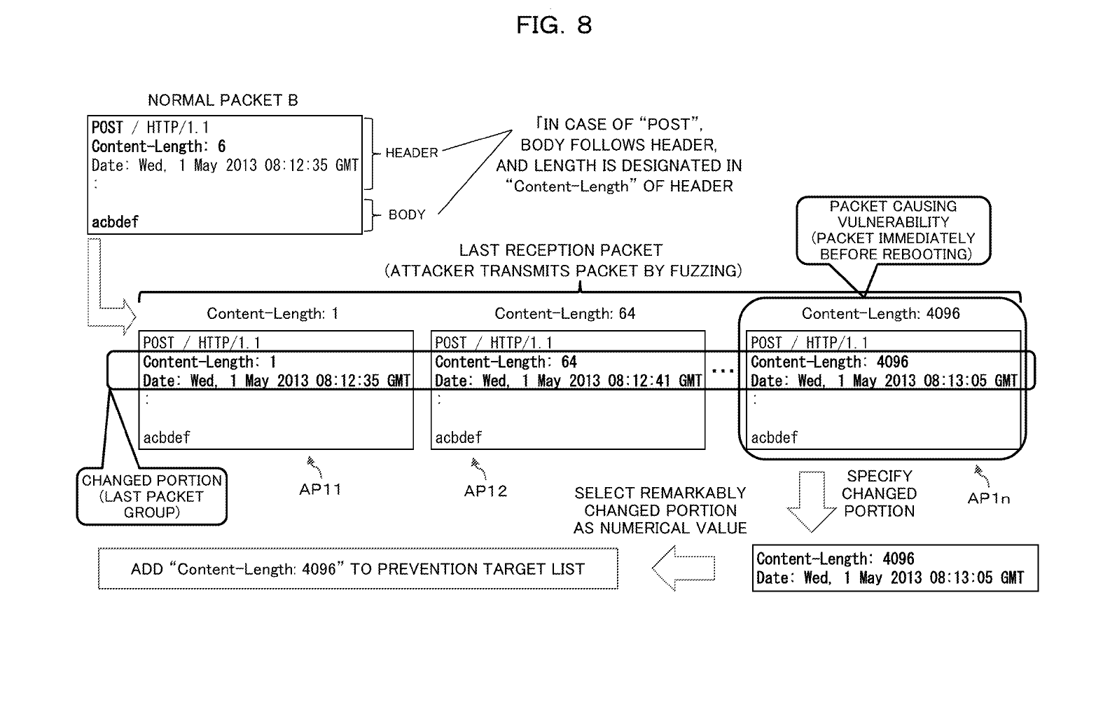

FIG. 8 is a diagram for describing a creation method of criterion information in the network filtering device 10 as the second embodiment of the invention.

FIG. 8 illustrates an example in which the plurality of attacking packets are created based on a normal packet B. In the example illustrated in FIG. 8, a plurality of attacking packets AP11 to AP1n (n is a natural number) are created while the value “6” of the data item “Content-Length” for the header of the normal packet B is changed in various types.

Even FIG. 8 illustrates an example in which the protection target apparatus 110 is assumed as a Web server and receives a packet as an HTTP request.

Herein, the normal packet B shows a portion of various headers of a HTTP protocol, and is a packet of a POST method. Such information is included in one packet. The attacking packets AP11 to AP1n show exemplary patterns which are created by an attacker 30 using a known fuzzing technique. These attacking packets AP11 to AP1n are patterns which are mainly used for checking buffer overflow.

In the second embodiment, by the fuzzing attack, the value of the data item “Content-Length” is made different in order to create the plurality of attacking packets having different values of characters included in the data item “Content-Length”.

Specifically, in the attacking packet AP11, ‘1’ is set as the data item “Content-Length”, and in the attacking packet AP12, ‘64’ is set as the data item “Content-Length”. Further, in the attacking packet AP1n, “4096” is set as the data item “Content-Length”.

Then, for example, a failure is not detected when the protection target apparatus 110 receives the attacking packets AP11 and AP12 are received. Then, when the attacking packet AP1n is received, the failure is detected.

In such a case, similarly to the first embodiment, the attacking packet AP1n which is received immediately before the protection target apparatus 110 detects the failure is estimated as a cause packet (the first data packet) which causes the failure in the protection target apparatus 110.

Then, in the cause packet, a portion (a changed portion) different between the last received other packets AP11 and AP12 is estimated as a factor (an abnormality cause) which causes the failure in the protection target apparatus 110.

Herein, the prevention target list generating unit 11 specifies a portion which is changed between the last received other attacking packets AP11 and AP12 in the cause packet.

Even in the second embodiment, similarly to the first embodiment the HTTP request is used as a packet, the changed portion is separated from each header and further separated into a data item and a value (separation using “:”) of the header, and the values of the same data item are compared.

Then, in the second embodiment, the size of the numerical value is used for the comparison as a comparison method.

In the example illustrated in FIG. 8, the value of the data item “Content-Length” and the value of the data item “Date” are different from each other in the attacking packets AP11 to AP1n.

Herein, in the packet of POST, a body follows the header and the length thereof is designated in “Content-Length”.

The prevention target list generating unit 11 specifies the value of the data item “Date” and the value of the data item “Content-Length” in the cause packet as portions which are different from the last received other attacking packets AP11 and AP12.

In this way, the data item “Date” and the data item “Content-Length” are included in the changed portion. However, similarly to the first embodiment, since the data item “Date” is information indicating a reception time of the packet, it is a matter of course that the numerical values thereof are different between the attacking packets AP11 to AP1n.

The value of the data item “Date” is different in each packet, but the change in size of the numerical value falls within a valid range as a value indicating a date.

On the other hand, as described above, the numerical value of the data item “Content-Length” is made different among the attacking packets AP11 to AP1n by the fuzzing attack. In other words, the size of the numerical value of the time and data item “Content-Length” is remarkably different in each packet.

In the second embodiment, the prevention target list generating unit 11 specifies an abnormality causing packet item among the plurality of packets based on each value of the data item. Specifically, in a case where the size of the value of the data item is different, for example, by 256 or more in the plurality of packets, it is considered as “remarkably different”.

The lengths of the respective data items “Content-Length” in the reception packets are “1”, “64”, . . . , and “4096”. The maximum value of the respective values set in the data item “Content-Length” is “4096” of the attacking packet AP1n, and the minimum value is “1” of the attacking packet AP1. A difference (a difference value) between the maximum value and the minimum value is calculated as 4096−1=4095.

Since the maximum value “1” and the minimum value “4096” have a difference by 256 or more, it can be considered that there is a remarkable change. The prevention target list generating unit 11 compares the calculated difference value “4095” and a predetermined threshold (for example, “256”). In a case where the difference value is larger than the threshold, the prevention target list generating unit 11 determines that a remarkably-changed portion is the length of the value of the data item “Content-Length”, and the data item “Content-Length” is the abnormality causing packet item.

On the other hand, the number of characters set in the data item “Date” is the same in the respective attacking packets AP11 to AP1n. Therefore, the differences (the difference values) between the maximum values and the minimum values are calculated as “0”.

The prevention target list generating unit 11 compares the calculated difference value “0” and a predetermined threshold (for example, “30”). Since the calculated difference value “0” is smaller than the threshold, the data item “Date” is excluded from the abnormality causing packet item.

In other words, in the second embodiment, an item of which the number of characters is changed by the threshold or more from another packet having no detected failure is specified as the abnormality causing packet item in the cause packet. Therefore, the data item, such as the reception time and date and the transmission time and date of the packet, which is naturally considered to have a different numerical value in the plurality of packets can be excluded from the abnormality causing packet item, so that the process can be performed with efficiency.

As described above, actually there is a strong possibility that the failure occurs due to the vulnerability in the protection target apparatus 110, and the abnormality causing packet item is specified by the combination with the last received packet. Then, it can be analyzed “in a case where the length of the data item “Content-Length” is 256 or more, the vulnerability occurs” with reference to the size of the numerical value of the abnormality causing packet item (the data item “Content-Length” in the example) in the attacking packet AP1n which is the cause packet. Therefore, when the result is added to the prevention target list L1, it is possible to reject the attacking packet in which the length of the data item “Content-Length” is “4096” or more.

The prevention target list generating unit 11 determines the abnormality causing packet item, which is specified as above in the attacking packet AP1n, as the criterion information, and registers the abnormality causing data specified as the criterion information in the prevention target list L1. In other words, the prevention target list generating unit 11 extracts the value of the abnormality causing packet item from the attacking packet AP1n which causes the failure in the protection target apparatus 110, and registers the extract value as the item “threshold” of the prevention target list L1.

In this way, the network filtering device 10 as the second embodiment of the invention can also achieve the same operational advantage as that of the first embodiment described above.

### (C) Others

The disclosed technology is not limited to the above-mentioned embodiments, and various modifications can be made in a scope not departing from the spirit of the embodiment. The respective configurations and the respective processes in the embodiment can be optionally used as needed, or may be implemented in an appropriate combination.

For example, by combining the first embodiment and the second embodiment, the prevention target list generating unit 11 may specify the abnormality causing packet item among a plurality of packets based on the number of characters of the value of the data item, and may specify the abnormality causing packet item among the plurality of packets based on the size of the value of the data item.

In this case, a threshold of the number of characters relating to the data item “Host” and a threshold of the size of the numerical value relating to the data item “Content-Length” are registered in the prevention target list L1. The filtering unit 16 compares each of the plurality of these thresholds and the value of the data item corresponding to the header of the received packet.

Further, in the above-mentioned embodiments, the network filtering device 10 performs the respective processes in units of packets received from the network 150, but the unit of processing is not limited thereto. A format of data received from the network 150 may be any format other than the packet.

Furthermore, in the above-mentioned embodiments, in a case where the value of the data item in the received packet is larger than the threshold registered in the prevention target list L1, the filtering unit 16 determines that the received packet is a risk packet, but the invention is not limited thereto. For example, in a case where the value of the data item in the received packet is smaller than the threshold registered in the prevention target list L1, the received packet may be determined as the risk packet. Further, in a case where the value of the data item in the received packet is equal or substantially equal to the threshold registered in the prevention target list L1, the received packet may be determined as the risk packet, and the invention can be implemented in various forms.

Further, it is possible for a person skilled in the art to implement/manufacture the embodiments through the above-mentioned disclosure.

According to an embodiment, a machine connected to a network can be effectively protected.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A network filtering device comprising:
a monitoring unit configured to monitor an apparatus which receives a data packet through a network;
a storage unit configured, when abnormality of the apparatus is detected, to store a first data packet which causes the abnormality;
a comparison unit configured to compare a second data packet received by the apparatus and the first data packet;
a specification unit configured to specify a portion in the first data packet which is changed by a threshold or more from the second data packet; and
a registration unit configured to register data of the specified portion.

2. The network filtering device according to claim 1, further comprising
a filtering unit configured to compare data which is in the data packet received through the network and which corresponds to the portion specified by the specification unit with the data which is registered in the registration unit, and to suppress the received data packet from being transmitted when the data of the received data packet exceeds the data registered in the registration unit.

3. A network filtering method comprising:
monitoring an apparatus which receives a data packet through a network;
storing, when abnormality of the apparatus is detected, a first data packet which causes the abnormality;
comparing a second data packet received by the apparatus and the first data packet;
specifying a portion in the first data packet which is changed by a threshold or more from the second data packet; and
registering data of the specified portion.

4. The network filtering method according to claim 3, further comprising:
comparing data which is in the data packet received through the network and which corresponds to the specified portion with the registered data; and
suppressing the received data packet from being transmitted when the data of the received data packet exceeds the registered data.

5. A computer-readable recording medium having stored therein a program for causing a computer to execute a network filtering process comprising:
monitoring an apparatus which receives a data packet through a network;
storing, when abnormality of the apparatus is detected, a first data packet which causes the abnormality;
comparing a second data packet received by the apparatus and the first data packet;
specifying a portion in the first data packet which is changed by a threshold or more from the second data packet; and
registering data of the specified portion.

6. The computer-readable recording medium having stored therein the program according to claim 5, wherein the process further comprises:
comparing data which is in the data packet received through the network and which corresponds to the specified portion with the registered data; and
suppressing the received data packet from being transmitted when the data of the received data packet exceeds the registered data.
